(19) United States
(12) Patent Application Publication
(10) Pub. No.: US 2026/0351919 A1
(43) Pub. Date: Nov. 5, 2026

(54) OPTICAL FIBER HAVING CORES OF DIFFERENT DOPING CONCENTRATIONS AND OPTICAL AMPLIFIERS USING SAME

(71) Applicant: II-VI Delaware, Inc., Wilmington, DE (US)

(72) Inventors: Ian McClean, Brixham (GB); Mark Lydon, Edinburgh (GB); Joshua Bradford, Orlando, FL (US)

(21) Appl. No.: 19/195,987

(22) Filed: May 1, 2025

(51) Int. Cl. H01S 3/067

(52) U.S. Cl. CPC H01S 3/06716

(57) ABSTRACT

An optical fiber may include a first fiber core doped with rare-earth ions, a second fiber core doped with rare-earth ions, and a cladding surrounding each of the first fiber core and the second fiber core. A second concentration of rare-earth ions in the second fiber core may be greater than a first concentration of rare-earth ions in the first fiber core. An optical amplifier may include an optical fiber coil comprising a single length of such an optical fiber. The optical amplifier may also include one or more multiplexers that mix pump light with a first optical signal and direct the mixed first optical signal into the first fiber core of the optical fiber coil. The one or more multiplexers may also mix pump light with a second optical signal and direct the mixed second optical signal into the second fiber core of the optical fiber coil.

### TECHNICAL FIELD

Aspects of the present disclosure relate to optical fibers and optical amplifiers.

### BACKGROUND

Optical communication systems send data via optical signals, which are modulated light of varying wavelengths. Such optical signals may experience various optical losses as they propagate along the optical fiber and through various optical components. To counteract such losses, optical communication systems commonly include erbium-doped fiber amplifier (EDFA) components at various stages to provide boost amplification to the optical signal and restore such losses. To this end, EDFA components include a length of erbium-doped fiber that provides optical gain to an optical signal propagating through the length of erbium-doped fiber. Moreover, the magnitude of such optical gain is dependent on an erbium absorption length provided by the length of erbium-doped fiber.

Two different bands known as the C-band (conventional band) and the L-band (long band) are commonly used by optical communications systems. Until recently the C-band was the main transmission band. But, optical communication systems that use both the C-band and the L-band are now commonly deployed.

While similar EDFA components may be used to amplify C-band optical signals and to amplify L-band optical signals, L-band EDFA components generally require a higher erbium absorption length than C-band EDFA components. As such, conventional optical communication systems include C-band EDFA components for amplifying C-band optical signals and separate L-band EDFA components for amplifying L-band optical signals in order to accommodate their different erbium absorption length requirements.

Specifically, such conventional optical communication systems may include C-band EDFA components that each include erbium-doped optical fiber coils having a first length suitable for amplifying C-band optical signals. Such conventional optical communications systems may further include L-band EDFA components that each include erbium-doped optical fiber coils having a second length that is longer the first length used by the C-band optical signals so as to provide suitable optical gain for L-band optical signals. However, such duplication of EDFA components and optical fiber coils increases costs associated with implementing and deploying optical communication systems that utilize both the C-band and the L-band.

Further limitations and disadvantages of conventional and traditional approaches will become apparent to one of skill in the art, through comparison of such approaches with some aspects of the present disclosure as set forth in the remainder of the present application with reference to the drawings.

BRIEF SUMMARY OF THE DISCLOSURE

Shown in and/or described in connection with at least one of the figures, and set forth more completely in the claims, are optical fibers having multiple cores of different rare-earth-doped concentrations. Optical amplifiers are also shown and described that use such optical fibers to simultaneously support optical communications across multiple bands (e.g., C-band and L-band).

These and other advantages, aspects, and novel features of the present disclosure, as well as details of illustrated embodiments thereof, will be more fully understood from the following description and drawings.

### BRIEF DESCRIPTION OF THE DRAWINGS

Various features and advantages of the present disclosure may be more readily understood with reference to the following detailed description taken in conjunction with the accompanying drawings, wherein like reference numerals designate like structural elements.

FIG. 1 depicts an embodiment of C-band erbium-doped fiber amplifier (EDFA) component.

FIG. 2 depicts a single-stage L-band EDFA component.

FIG. 3 depicts a two-stage L-band EDFA component.

FIG. 4 depicts an embodiment of a multi-core optical fiber having two fiber cores, where each fiber core has a different rare-earth doping concentration.

FIG. 5 depicts an embodiment of a rare-earth-doped optical fiber amplifier (OFA) component using the multi-core optical fiber of FIG. 4 to provide optical gain for optical signals of different bands (e.g., C-band and L-band).

FIG. 6 depicts another embodiment of a multi-core optical fiber having three fiber cores, where each fiber core has a different rare-earth doping concentration.

FIG. 7 depicts an embodiment of a rare-earth-doped OFA component using the multi-core optical fiber of FIG. 6 to provide optical gain for optical signals of different bands (e.g., C-band and L-band).

### DESCRIPTION

The present disclosure is directed to an optical fiber comprising multiple rare-earth-doped fiber cores, where each fiber core may have a different doping concentration. The present disclosure is further directed to rare-earth-doped optical fiber amplifier (OFA) components comprising an optical fiber having multiple rare-earth-doped fiber cores, where each fiber core may have a different doping concentration. In particular, the doping concentrations may differ so as to provide each band and/or stage of the OFA component suitable optical gain over a same length of the optical fiber. In this manner, multiple optical fiber coils found in conventional OFA components may be implemented with a single optical fiber coil of an OFA component.

The figures illustrate a general manner of construction. Descriptions and details of well-known features and techniques may be omitted to avoid unnecessarily obscuring the present disclosure. In addition, elements in the drawing figures are not necessarily drawn to scale. For example, the dimensions of some of the elements in the figures may be exaggerated relative to other elements to help improve understanding of the examples discussed in the present disclosure. The same reference numerals in different figures denote the same elements.

The term “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

The terms “comprises,” “comprising,” “includes,” and/or “including,” are “open ended” terms and specify the presence of stated features, but do not preclude the presence or addition of one or more other features.

The terms “first,” “second,” etc. may be used herein to describe various elements, and these elements should not be limited by these terms. These terms are only used to distinguish one element from another. Thus, for example, a first element discussed in this disclosure could be termed a second element without departing from the teachings of the present disclosure.

Unless specified otherwise, the term “coupled” may be used to describe two elements directly contacting each other or describe two elements indirectly connected by one or more other elements. For example, if element A is coupled to element B, then element A may be directly contacting element B or indirectly connected to element B by an intervening element C. Similarly, the terms “over” or “on” may be used to describe two elements directly contacting each other or describe two elements indirectly connected by one or more other elements.

Also, any numerical range recited herein is intended to include all sub-ranges subsumed therein. For example, a range of “1 to 10” is intended to include any and all sub-ranges between and including the recited minimum value of 1 and the recited maximum value of 10, that is, all sub-ranges beginning with a minimum value equal to or greater than 1 and ending with a maximum value equal to or less than 10, and all sub-ranges in-between, e.g., 1 to 6.3, or 5.5 to 10, or 2.7 to 6.1.

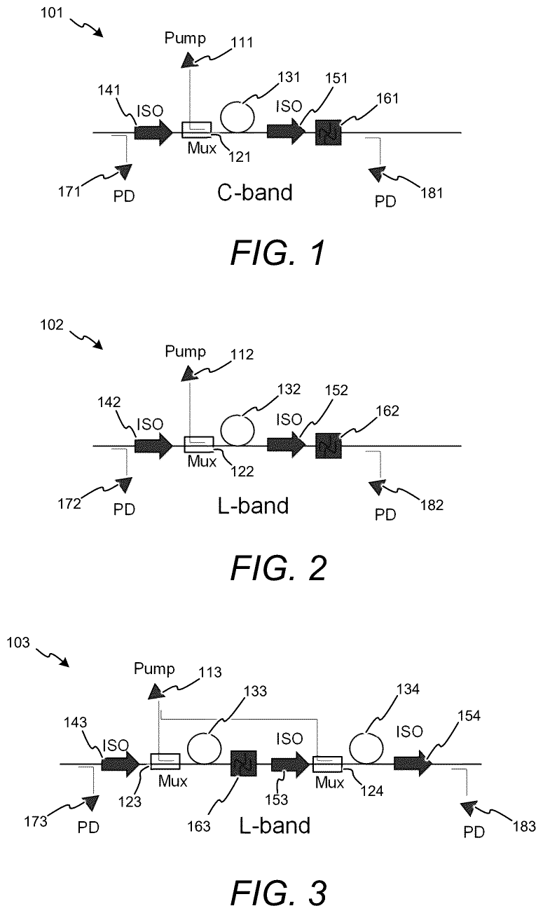

Referring now to FIG. 1, a C-band erbium-doped fiber amplifier (EDFA) component 101 is depicted. The C-band EDFA component 101 includes an optical pump 111 that generates a relatively high-powered beam or pump light. The C-band EDFA component 101 may also include a multiplexer 121 that mixes a C-band optical input signal with the pump light provided by the optical pump 111. The multiplexer 121 may guide the mixed light signal into a fiber core of an optical fiber coil 131. The high-powered pump light of the mixed optical signal excites erbium ions in the fiber core to a higher-energy state. When photons of the C-band optical input signal encounter the excited erbium ions, the erbium ions undergo stimulated emission and return to a lower-energy state. In its return to the lower-energy state, the erbium gives up its energy in the form of additional photons which are exactly in the same phase and direction as the C-band optical input signal. More specifically, the optical pump 111 may inject laser light of 980 or 1480 nanometers (nm) into the erbium-doped optical fiber to create optical gain of a waveband around 1550 nm. Thus, the C-band optical input signal with its band around 1550 nm is amplified as it propagates along the length of the optical fiber coil 131.

A first optical isolator 141 may be positioned on an input side of the optical fiber coil 131 and a second optical isolator 151 may be positioned on an output side of the optical fiber coil 131. The optical isolators 141, 151 may prevent reflections and possible lasing of the C-band optical input signal. Furthermore, the C-band EDFA component 101 may include a gain flattening filter (GFF) 161 which flattens the gain of the C-band optical input signal to ensure a similar gain is obtained across the C-band of the resulting C-band optical output signal.

Further, an optical input monitor 171 may be positioned at an optical input of the C-band EDFA component 101. The optical input monitor 171 may include one or more optical sensors (e.g., one or more photo-diodes) that sense one or more characteristics (e.g., average power) of the C-band optical input signal as it enters the C-band EDFA component 101. The optical input monitor 171 may further generate one or more electrical signals that are representative of the sensed one or more characteristics of the C-band optical input signal.

Similarly, an optical output monitor 181 may be positioned at an optical output of the C-band EDFA component 101. The optical output monitor 181 may comprise one or more optical sensors (e.g., one or more photo-diodes) that sense one or more characteristics (e.g., average power) of the C-band optical output signal as it exits the C-band EDFA component 101. The optical output monitor 181 may further generate one or more electrical signals that are representative of the sensed one or more characteristics of the C-band optical output signal. Via such electrical signals, optical gain may be monitored and proper operation of the C-band EDFA component 101 may be assessed.

FIG. 2 depicts a single-stage, L-band EDFA component 102. The single stage, L-band EDFA component 102 may be implemented in a similar manner as the C-band EDFA component 101 of FIG. 1. In particular, the single-stage, L-band EDFA component 102 may include an optical pump 112 that generates a relatively high-powered beam or pump light and a multiplexer 122 that mixes an L-band optical input signal with the pump light provided by the optical pump 112. The multiplexer 122 may guide the mixed light signal into a fiber core of an optical fiber coil 132. The high-powered pump light of the mixed optical signal excites erbium ions in the fiber core to a higher-energy state. When the photons of the L-band optical input signal encounter the excited erbium ions, the erbium ions undergo stimulated emission and return to a lower-energy state. In the return to the lower-energy state, the erbium gives up its energy in the form of additional photons which are exactly in the same phase and direction as the L-band optical input signal. More specifically, the optical pump 112 may inject laser light of 980 or 1480 nanometers (nm) into the erbium-doped optical fiber to create optical gain of a waveband around 1590 nm. Thus, the L-band optical input signal with its waveband near 1590 nm is amplified as it propagates along the length of the optical fiber coil 132.

A first optical isolator 142 may be positioned on an input side of the optical fiber coil 132 and a second optical isolator 152 may be positioned on an output side of the optical fiber coil 132. The optical isolators 142, 152 may prevent reflections and possible lasing of the L-band optical input signal. Furthermore, the L-band EDFA component 102 may include a gain flattening filter (GFF) 162 which flattens the gain of the L-band optical input signal to ensure a similar gain is obtained across the L-band of the resulting L-band optical output signal.

Further, an optical input monitor 172 may be positioned at an optical input of the L-band EDFA component 102. The optical input monitor 172 may include one or more optical sensors (e.g., one or more photo-diodes) that sense one or more characteristics (e.g., average power) of the L-band optical input signal as it enters the L-band EDFA component 102. The optical input monitor 172 may further generate one or more electrical signals that are representative of the sensed one or more characteristics of the L-band optical input signal.

Similarly, an optical output monitor 182 may be positioned at an optical output of the L-band EDFA component 102. The optical output monitor 182 may comprise one or more optical sensors (e.g., one or more photo-diodes) that sense one or more characteristics (e.g., average power) of the L-band optical output signal as it exits the L-band EDFA component 102. The optical output monitor 182 may further generate one or more electrical signals that are representative of the sensed one or more characteristics of the L-band optical output signal. Via such electrical signals, optical gain may be monitored and proper operation of the L-band EDFA component 102 may be assessed.

FIG. 3 depicts a two-stage, L-band EDFA component 103. The two-stage, L-band EDFA component 103 generally adds a second stage to the single stage, L-band EDFA component of 102 of FIG. 2. In particular, the first stage of the L-band EDFA component 103 may include an optical pump 113, a first multiplexer 123, a first optical fiber coil 133, a first optical isolator 143, a second optical isolator 153, a gain flattening filter (GFF) 163, and an optical input monitor 173, which generally operate in a manner similar to corresponding components of the L-band EDFA component 102.

The second stage of L-band EDFA component 103 may include a second multiplexer 124 that mixes L-band optical output signal of the first stage with the pump light provided by the optical pump 113. The second multiplexer 124 may guide the mixed light signal into a fiber core of a second optical fiber coil 134. The high-powered pump light of the mixed optical signal excites erbium ions in the fiber core of the second optical fiber coil 134 to a higher-energy state. When photons of the L-band optical output signal from the first stage encounter the excited erbium ions, the erbium ions undergo stimulated emission and return to a lower-energy state. In its return to the lower-energy state, the erbium gives up its energy in the form of additional photons which are exactly in the same phase and direction as the L-band optical output signal of the first stage. More specifically, the optical pump 113 may inject laser light of 980 or 1480 nanometers (nm) into the erbium-doped optical fiber to create optical gain of a waveband around 1590 nm. Thus, the L-band optical input signal with its waveband near 1590 nm is further amplified as it propagates along the length of the second optical fiber coil 134.

Similar to the single-stage L-band EDFA component 102, the two-stage L-band EDFA component 103 includes a first optical isolator 143 positioned on an input side of a first optical fiber coil 133 and a second optical isolator 153 positioned on an output side of the first optical fiber coil 133. The optical isolators 143, 153 may prevent reflections and possible lasing of the first stage L-band optical input signal. The two-stage EDFA component 103 further includes a third optical isolator 154 positioned on an output side of the second optical fiber coil 134. Moreover, the second optical isolator 153 is further positioned on an input side of the second optical fiber coil 134. As such, the optical isolators 153, 154 may prevent reflections and possible lasing of the second stage L-band optical input signal.

Further, an optical input monitor 173 may be positioned at an optical input of the L-band EDFA component 103. The optical input monitor 173 may include one or more optical sensors (e.g., one or more photo-diodes) that sense one or more characteristics (e.g., average power) of the L-band optical input signal as it enters the L-band EDFA component 103. The optical input monitor 173 may further generate one or more electrical signals that are representative of the sensed one or more characteristics of the L-band optical input signal.

Similarly, an optical output monitor 183 may be positioned at an optical output of the L-band EDFA component 103. The optical output monitor 183 may comprise one or more optical sensors (e.g., one or more photo-diodes) that sense one or more characteristics (e.g., average power) of the L-band optical output signal as it exits the L-band EDFA component 103. The optical output monitor 183 may further generate one or more electrical signals that are representative of the sensed one or more characteristics of the L-band optical output signal. Via such electrical signals, optical gain may be monitored and proper operation of the L-band EDFA component 103 may be assessed.

The EDFA components 101, 102, 103 of FIGS. 1-3 rely upon erbium-doped optical fibers for optical gain. In general, the greater the number of rare-earth ions (e.g., trivalent erbium ions (Er³⁺)) an optical signal encounters as it propagates along an optical fiber core, the greater the optical gain. Thus, for a given doping concentration, one may increase the optical gain provided by an optical fiber by increasing the length of the rare-earth doped fiber core along which the optical signal propagates. Such an increase in length increases the quantity of rare-earth ions encountered as the optical signal propagates the length of the optical fiber, and thus increases optical gain. Conversely, for a given doping concentration, one may decrease the optical gain provided by an optical fiber by decreasing the length of the rare-earth doped fiber core along which the optical signal propagates. Such a decrease in length decreases the quantity of rare-earth ions encountered as the optical signal propagates the length of the optical fiber, and thus decreases optical gain.

Similarly, for a given length of optical fiber, one may increase the optical gain provided by an optical fiber by increasing the doping concentration of rare-earth ions in the fiber core through which the optical signal propagates. Such an increase in doping concentration increases the quantity of rare-earth ions encountered as the optical signal propagates the given length of the fiber core, and thus generally increases optical gain. Conversely, for a given length of the optical fiber, one may decrease the optical gain provided by the optical fiber by decreasing the doping concentration of the rare-earth ions in the fiber core along which the optical signal propagates. Such a decrease in doping concentration decreases the quantity of rare-earth ions encountered as the optical signal propagates the given length of the fiber core, and thus generally decreases optical gain.

More specifically, to achieve a particular optical gain (dB), an erbium-doped optical fiber provides a corresponding amount of total absorption of the mixed optical signal. Furthermore, the concentration of erbium ions in an erbium-doped optical fiber provides a corresponding absorption level (i.e. absorption (dB) per a unit length (m)) Thus, the physical length or absorption length of the erbium-doped fiber depends on the total absorption needed to provide the desired optical gain and the absorption level provided by the concentration of erbium ions. Namely, the absorption length (e.g., in meters) may equal the total absorption (dB) to be provided by the EDFA component divided by the absorption level (dB/m) provided by the doping concentration of erbium ions.

For any given two of absorption length, total absorption, and absorption level, one may determine the third within certain limits. For example, the gain effect provided by increasing the doping concentration has an upper limit. In particular, once the upper limit is reached optical signal gain decreases with further increases in doping concentration. Moreover, optical gain provided by such encounters with rare-earth ions differs based on the wavelengths of the optical signals encountering the rare-earth ions. In particular, an L-band optical signal typically needs to encounter a greater number of rare-earth ions than a C-band optical signal to achieve suitable optical gain. Thus, assuming a same doping concentration, a longer optical fiber is needed to provide an L-band optical signal with suitable optical gain than is needed to provide a C-band optical signal with suitable optical gain.

For example, in one embodiment, the EDFA components 101, 102, 103 each utilize optical fiber of a different length when implemented with optical fibers having a same erbium doping concentration. More specifically, for a given doping concentration, the C-band EDFA component 101 may use an optical fiber coil 131 with a length of 5 meters; the single-stage L-band EDFA component 102 may use an optical fiber coil 132 with a length of 6 meters; and the two-stage L-band EDFA component 103 may use a first optical fiber coil 132 with a length of 6 meters and a second optical fiber coil 134 of 17 meters. Thus, using the optical fiber of the C-band EDFA component 101 as a base line of 1.0, each first optical fiber coil 132, 133 for the first stage the L-band EDFA components 102, 103 is 1.2 times the length of the optical fiber coil 131 for C-band EDFA component 101, and the second optical fiber coil 134 for the second stage of the L-band EDFA component 103 is 3.2 times the length of the optical fiber coil 131 for the C-band EDFA component 101.

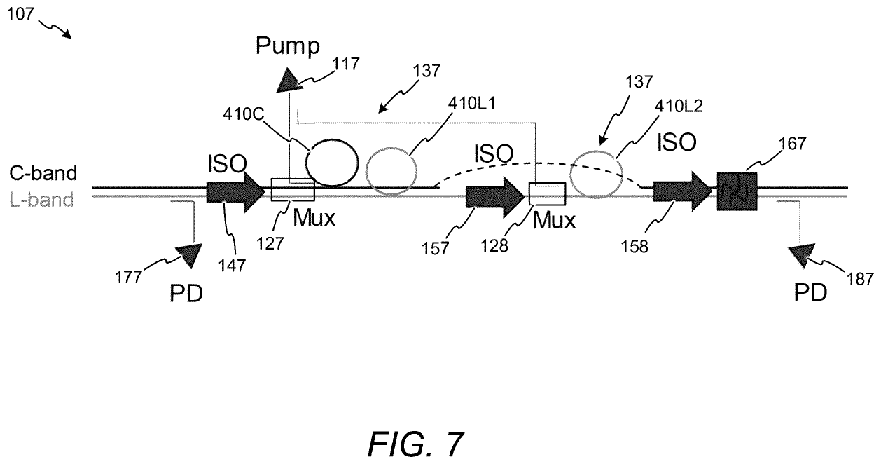

As noted above, optical gain provided by an optical fiber may be adjusted by adjusting the length of the optical fiber and/or the absorption level (e.g., doping concentration) of the optical fiber. The optical fiber amplifier (OFA) components 105 and 107 of FIGS. 5 and 7 take advantage of this property to provide components that are capable of providing optical gain similar to the EDFA components 101, 102, 103, but with a single length of optical fiber which has multiple fiber cores with different absorption levels (e.g., doping concentrations).

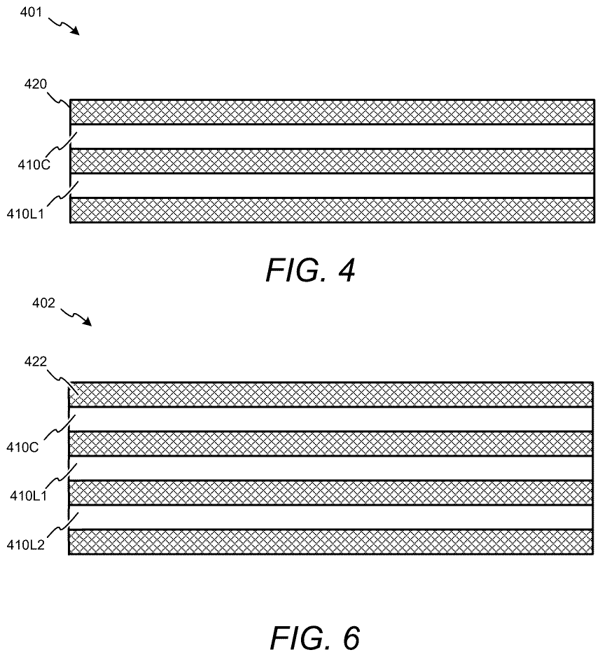

To this end, FIG. 4 depicts an example embodiment of an optical fiber 401 with multiple fiber cores. In particular, the optical fiber 401 comprises a first fiber core 410C, a second fiber core 410L1, and a cladding 420. The cladding 420 surrounds or encases the first fiber core 410C. Further, the cladding 420 also surrounds or encases the second fiber core 410L1.

The first fiber core 410C and second fiber core 410L1 may be made of various optically transmissive materials such as, for example, plastic, glass, silica, etc. Similarly, the cladding 420 may be made of various optically transmissive materials such as, for example, plastic, glass, silica, etc. However, the material selected for the cladding 420 has a refractive index that is lower than a refractive index of the material selected for the first fiber core 410C. Due to such difference in refractive indices of the cladding 420 and the first fiber core 410L1, total internal reflection may occur at the interface between the first fiber core 410C and the cladding 420, thus guiding a first optical signal propagating through the first fiber core 410C.

Similarly, the material selected for the cladding 420 has a refractive index that is also lower than the refractive index of the material selected for the second fiber core 410L1. Due to such difference in refractive indices of the cladding 420 and the second fiber core 410L1, total internal reflection may occur at the interface between the second fiber core 410L1 and the cladding 420, thus guiding a second optical signal propagating through the second fiber core 410L1.

While the first fiber core 410C and the second fiber core 410L1 may be formed from the same or similar materials, the first fiber core 410C and the second fiber core 410L1 may be differently doped to provide suitable optical gain for their respective optical signals. In particular, the first fiber core 410C may be doped with a first concentration of erbium ions (e.g., trivalent erbium ions (Er³⁺)) and/or other rare-earth ions. The second fiber core 410L1 may be doped with a second concentration of erbium ions (e.g., trivalent erbium ions (Er³⁺)) and/or other rare-earth ions. In particular, the first concentration and the second concentration may be specified such that the respective fiber cores 410C, 410L1 provide suitable optical gain for their respective optical signals over a same length of the optical fiber 401.

In various embodiments, the doping concentration of the first fiber core 410C is specified such that the first fiber core 410C provides a first optical signal of a first waveband (e.g., C-band) with suitable optical gain over a specified length (e.g., 6 meters) of the optical fiber 401. Further, the doping concentration of the second fiber core 410L1 is specified such that the second fiber core 410L1 provides a second optical signal of a second waveband (e.g., L-band) with suitable optical gain over the same specified length (e.g., 6 meters) of the optical fiber 401. In this manner, the optical fiber 401 may permit the construction of a rare-earth-doped OFA component with a single length of optical fiber that is capable of providing a suitable optical boost or gain for optical signals of two different wavebands (e.g., C-band and L-band).

More specifically, the first fiber core 410C may be doped to a base line concentration that provides suitable optical gain for C-band optical signals for a specified length (e.g., 6 meters) of an optical fiber coil. Similarly, the second fiber core 410L1 may be doped to a concentration level that is 1.2 times the base line concentration of the first fiber core 410C. In this manner, a C-band optical signal passing through the specified length (e.g., 6 meters) of the first fiber core 410C may effectively encounter a same quantity of rare-earth ions as it would have encountered over the 5 meter length of optical fiber coil 131 of FIG. 1. Further, the L-band optical signal passing through the specified length (e.g., 6 meters) of the second fiber core 410L1 may effectively encounter a same quantity of rare-earth ions as it would have encountered over the 6 meter length of optical fiber coil 132 of FIG. 2.

As noted above, the second fiber core 410L1 may have a concentration of rare-earth ions that is 1.2 times (120%) a concentration of rare-earth ions in the first fiber core 410C. However, the difference in concentrations is dependent on various factors such as the waveband, rare-earth ions, fiber core materials, etc. As such, the doping concentration of rare-earth ions in the second fiber core 410L1 in various embodiments may be at greater than 1.05 (105 %), 1.10 (110 %), 1.15 (115 %), 1.20 (120 %), 2.0 (200 %), 3.0 (300 %), or any sub-range subsumed therein, times (of) the doping concentration of rare-earth ions in the second fiber core 410L1.

Referring now to FIG. 5, a rare-earth-doped OFA component 105 is depicted which uses an optical fiber similar to the optical fiber 401 of FIG. 4 for its optical fiber coil 135. In particular, the OFA component 105 may combine aspects of the C-band EDFA component 101 and the L-band EDFA component 102 to provide an OFA component 105 capable of providing both a C-band optical input signal and an L-band optical input signal with suitable optical gain. Moreover, the OFA component 105 may achieve such optical gain using a single length (e.g., 6 meters) of the multi-core optical fiber 401 for its optical fiber coil 135.

To this end, the OFA component 105 may include one or more optical pumps 115 that generate a relatively high-powered beam or pump light. The OFA component 105 may also include one or more multiplexers 125 that mix a C-band optical input signal and an L-band optical input signal with the pump light provided by the optical pump 115. The one or more multiplexers 125 may guide the mixed C-band light signal into a first fiber core 410C of optical fiber 401 used to form an optical fiber coil 135. The one or more multiplexers 125 may guide the mixed L-band light signal into a second fiber core 410L1 of the optical fiber 401 used to form the optical fiber coil 135. The high-powered pump light of the mixed optical signal may excite rare-earth ions (e.g., trivalent erbium ions (Er³⁺)) in the first fiber core 410C and the second fiber core 410L1 to a higher-energy state.

In some embodiments, the one or more optical pumps 115 may include a single optical pump and the one or more multiplexers 124 may include a single multiplexer that mixes a C-band optical input signal and an L-band optical input signal with the pump light provided by the single optical pump. The single multiplexer may guide the mixed C-band light signal into the first fiber core 410C of the optical fiber 401. Further, the single multiplexer may guide the mixed L-band light signal into the second fiber core 410L1 of the optical fiber 401.

In various embodiments, the one or more optical pumps 115 may include a C-band optical pump and an L-band optical pump. The C-band optical pump may generate a first pump signal for the C-band and an L-band optical pump may generate a second pump signal for the L-band. Furthermore, the one or more multiplexers 125 may include a C-band multiplexer and an L-band multiplexer. The C-band multiplexer may mix a C-band optical input signal with the first pump signal from the C-band optical pump and guide the mixed C-band light signal into the first fiber core 410C of the optical fiber 401. The L-band multiplexer may mix an L-band optical input signal with the second pump signal from the L-band optical pump and guide the mixed L-band light signal into the second fiber core 410L1 of the optical fiber 401.

When photons of the C-band optical input signal encounter the rare-earth ions in the first fiber core 410C, the rare-earth ions may undergo stimulated emission and may return to a lower-energy state. Similarly, when photons of the L-band optical input signal encounter the excited rare-earth ions in the second fiber core 410L1, the rare-earth ions may undergo stimulated emission and may return to a lower-energy state. In their return to the lower-energy state, the rare-earth ions may give up energy in the form of additional photons, which are exactly in the same phase and direction as their encountered C-band optical input signal or L-band optical input signal. In this manner, the first fiber core 410C and the second fiber core 410L1 may provide optical gain that boosts their respective C-band optical input signal and L-band optical input signal.

A first optical isolator 145 may be positioned on an input side of the optical fiber coil 135 to receive a C-band optical signal and an L-band optical signal. The receipt of such signals may be via separate optical fibers, via separate fiber cores of an optical fiber, and/or via free space. A second optical isolator 155 may be positioned after the optical fiber coil 135 to receive the boosted C-band optical signal and the boosted L-band optical signal. The optical isolators 145, 155 may prevent reflections and possible lasing of the boosted C-band optical signal and the boosted L-band optical signal.

The OFA component 105 may also include a gain flattening filter (GFF) 165 which flattens the gain of the boosted C-band optical signal and/or the boosted L-band optical signal to ensure a similar gain is obtained across the C-band of the resulting C-band optical output signal and across the L-band of the resulting L-band optical output signal. While FIG. 5 depicts the GFF 165 after the second optical isolator 155, the GFF 165 in some embodiments may be positioned between the optical fiber coil 135 and the second optical isolator 155.

In various embodiments, the multiplexer 125 and/or optical isolators 145, 155 may be coupled to the first fiber core 410C such that the C-band optical signal propagates through the first fiber core 410C in a first direction along the length of the optical fiber 401 used to implement the optical fiber coil 135. Moreover, the multiplexer 125 and/or optical isolators 145, 155 may be coupled to the second fiber core 410L1 such that the L-band signal propagates through the second fiber core 410L1 in a second direction along the length of the optical fiber 401 that is opposite the first direction of the C-band optical signal. Such propagation of the C-band optical signal and the L-band optical signal in opposite directions may reduce cross-talk between the two optical signals as they traverse the same length of the optical fiber 401.

Further, an optical input monitor 175 may be positioned at an optical input of the OFA component 105. The optical input monitor 175 may include one or more optical sensors (e.g., one or more photo-diodes) that sense one or more characteristics (e.g., average power) of the C-band optical input signal and the L-band optical input signal as they enter the OFA component 105. The optical input monitor 175 may further generate one or more electrical signals that are representative of the sensed one or more characteristics of the C-band optical input signal. The optical input monitor 175 may further generate one or more electrical signals that are representative of the sensed one or more characteristics of the L-band optical input signal.

Similarly, an optical output monitor 185 may be positioned at an optical output of the OFA component 105. The optical output monitor 185 may comprise one or more optical sensors (e.g., one or more photo-diodes) that sense one or more characteristics (e.g., average power) of the C-band optical output signal and the L-band optical output signal as they exit the OFA component 105. The optical output monitor 185 may further generate one or more electrical signals that are representative of the sensed one or more characteristics of the C-band optical output signal. The optical output monitor 185 may further generate one or more electrical signals that are representative of the sensed one or more characteristics of the L-band optical output signal. Via such electrical signals, optical gain may be monitored and proper operation of the OFA component 105 may be assessed.

The OFA component 105 of FIG. 5 may provide a C-band optical signal and an L-band optical signal with optical gain using a single length (e.g., 6 meters) of a multi-core optical fiber 401. Conversely, the EDFA component 101 of FIG. 1 uses a first length (e.g., 5 meter) of a first optical fiber to provide optical gain for a C-band optical signal and the EDFA component 102 of FIG. 2 uses a second length (e.g., 6 meters) of an optical fiber to provide optical gain for an L-band optical signal. Thus, one may reduce the total length of optical fiber used to provide optical gain for a C-band optical signal and an L-band optical signal by using the OFA component 105 of FIG. 5 instead of both the EDFA component 101 of FIG. 1 and the EDFA component 102 of FIG. 2. For example, the OFA component 105 may use 6 meters of the multi-core optical fiber 401, whereas the EDFA component 101 and the EDFA component 102 may combine to use 11 meters of erbium-doped optical fiber.

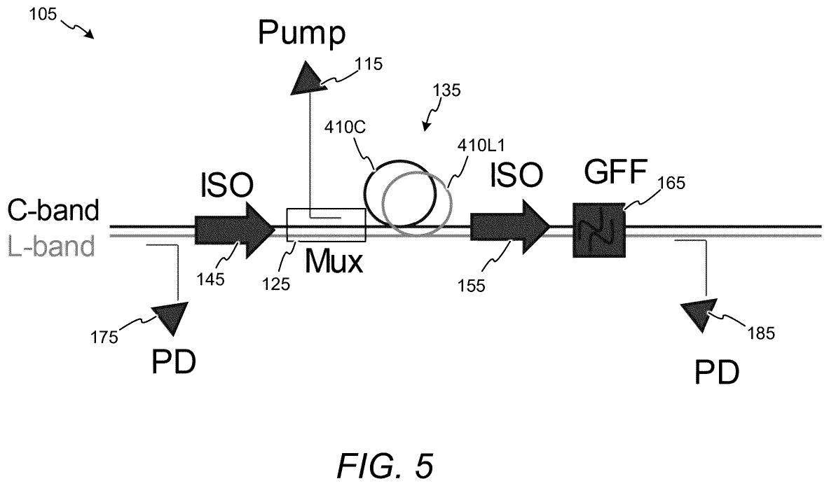

Referring now to FIG. 6, another embodiment of an optical fiber 402 with multiple fiber cores is shown. The optical fiber 402 may be implemented in a manner similar to the optical fiber 401 of FIG. 4. The optical fiber 402, however, may further include a third fiber core 410L2. More specifically, the optical fiber 402 may include a first fiber core 410C, a second fiber core 410L1, a third fiber core 410L2, and a cladding 422. The cladding 422 may surround or encase each of the first fiber core 410C, the second fiber core 410L1, and the third fiber core 410L2.

The first fiber core 410C, second fiber core 410L1, and third fiber core 410L2 may be made of various optically transmissive materials such as, for example, plastic, glass, silica, etc. Similarly, the cladding 422 may be made of various optically transmissive materials such as, for example, plastic, glass, silica, etc. However, the material selected for the cladding 422 has a refractive index that is lower than a refractive index of the material selected for the first fiber core 410C, a refractive index of the material selected for the second fiber core 410L1, and a refractive index of the material selected for the third fiber core 410L2. Due to such difference in refractive indices, total internal reflection may occur at the interface between each fiber core 410C, 410L1, 410L2 and the cladding 422, thus guiding an optical signal propagating through the respective fiber core 410C, 410L1, 410L2.

While the first fiber core 410C, the second fiber core 410L1, and the third fiber core 410L2 may be formed from the same or similar materials, the first fiber core 410C, the second fiber core 410L1, and the third fiber core 410L2 may be differently doped to provide suitable optical gain for their respective optical signals. In particular, the first fiber core 410C may be doped with a first concentration of erbium ions (e.g., trivalent erbium ions (Er³⁺)) and/or other rare-earth ions, the second fiber core 410L1 may be doped with a second concentration of erbium ions (e.g., trivalent erbium ions (Er³⁺)) and/or other rare-earth ions, and the third fiber core 410L2 may be doped with a third concentration of erbium ions (e.g., trivalent erbium ions (Er³⁺)) and/or other rare-earth ions. In particular, the first concentration, the second concentration, and third concentrations may be specified such that the respective fiber cores 410C, 410L1, 410L2 provide suitable optical gain for their respective optical signals over a same length of the optical fiber 402.

In various embodiments, the doping concentration of the first fiber core 410C, the doping concentration of the second fiber core 410L1, and the doping concentration of the third fiber core 410L2 are specified such that the first fiber core 410C provides a first optical signal of a first waveband (e.g., C-band) with suitable optical gain over a specified length (e.g., 17 meters) of the optical fiber 402, the second fiber core 410L1 provides a second optical signal of a second waveband (e.g., L-band) with suitable first stage optical gain over the same specified length (e.g., 17 meters) of the optical fiber 402, and the third fiber core 410L2 provides the second optical signal of the second waveband (e.g., L-band) with suitable second stage optical gain over the same specified length (e.g., 17 meters) of the optical fiber 402. In this manner, the optical fiber 402 may permit the construction of a rare-earth-doped OFA component with a single length of optical fiber that is capable of providing a suitable optical boost or gain for optical signals of two different wavebands (e.g., C-band and L-band).

More specifically, the first fiber core 410C may be doped to a base line concentration that provides suitable optical gain for C-band optical signals for a specified length (e.g., 17 meters) of an optical fiber coil. Similarly, the second fiber core 410L1 may be doped to a concentration level that is 1.2 times the base line concentration of the first fiber core 410C. Further, the third fiber core 410L2 may be doped to a concentration level that is 3.2 times the base line concentration of the first fiber core 410C. In this manner, a C-band optical signal passing through the specified length (e.g., 17 meters) of the first fiber core 410C may effectively encounter a same quantity of rare-earth ions as it would have encountered over the 5 meter length of optical fiber coil 131 of FIG. 1. Further, the L-band optical signal passing through the specified length (e.g., 17 meters) of the second fiber core 410L1 may effectively encounter a same quantity of rare-earth ions as it would have encountered over the six (6) meter length of the first optical fiber coil 133 of FIG. 3. Furthermore, the L-band optical signal passing through the specified length (e.g., 17 meters) of the third fiber core may effectively encounter a same quantity of rare-earth ions as it would have encountered over the 17 meter length of the second optical fiber coil 134 of FIG. 3.

As noted above, the second fiber core 410L1 may have a concentration of rare-earth ions that is 1.2 times (or 120%) a concentration of rare-earth ions in the first fiber core 410C, and the third fiber core 410L2 may have a concentration of rare-earth ions that is 3.2 times (or 320%) a concentration of rare-earth ions in the first fiber core 410C. However, the difference in concentrations is dependent on various factors such as the waveband, rare-earth ions, fiber core materials, etc. As such, the doping concentration of rare-earth ions in the second fiber core 410L1 and in the third fiber core 410L2 in various embodiments may be at 1.05 (105 %), 1.10 (110 %), 1.15 (115 %), 1.20 (120%), 2.0 (200 %), 3.2 (320 %), or any sub-range subsumed therein, times (of) the doping concentration of rare-earth ions in the second fiber core 410L1.

Referring now to FIG. 7, a rare-earth-doped OFA component 107 is depicted which uses an optical fiber similar to the optical fiber 402 of FIG. 6 for its optical fiber coil 137. In particular, the OFA component 107 may combine aspects of the C-band EDFA component 101 of FIG. 1 and the two-stage L-band EDFA component 103 of FIG. 3 to provide an OFA component 107 capable of providing suitable optical gain for both a C-band optical input signal and L-band optical input signal. Moreover, the OFA component 107 may achieve such optical gain using a single length of the multi-core optical fiber 402.

To this end, the OFA component 107 generally adds a second L-band stage to the OFA component of 105 of FIG. 5. In particular, the OFA component 107 may include an optical pump 117, a first multiplexer 127, an optical fiber coil 137, a first optical isolator 147, a second optical isolator 157, and an optical input monitor 177, which generally operate in a manner similar to corresponding components of the OFA component 105.

The second stage of the OFA component 107 may include a second multiplexer 128 that mixes a boosted L-band optical signal from the first stage with the pump light provided by the optical pump 117. The second multiplexer 128 may guide the mixed light signal into a third fiber core 410L2 of an optical fiber 402 used to implement the optical fiber coil 137. The high-powered pump light of the mixed optical signal excites rare-earth ions (e.g., trivalent erbium ions (Er3+)) in the third fiber core 410L2 to a higher-energy state. When photons of the boosted L-band optical signal from the first stage encounter the excited rare-earth ions, the rare-earth ions may undergo stimulated emission and may return to a lower-energy state. In its return to the lower-energy state, the rare-earth ions may give up their energy in the form of additional photons which may be exactly in the same phase and direction as the boosted L-band optical signal of the first stage. More specifically, the optical pump 117 may inject laser light of 980 or 1480 nanometers (nm) into the rare-earth-doped optical fiber to create optical gain of a waveband around 1550 nm. Thus, the boosted L-band optical signal with its waveband near 1550 nm is further amplified as it propagates along the length of the optical fiber coil 137.

Similar to the single-stage OFA component 105 of FIG. 5, the two-stage OFA component 107 may include a first optical isolator 147 positioned on an input side of the optical fiber coil 137 to receive a C-band optical signal and an L-band optical signal. The receipt of such signals may be via separate optical fibers, via separate fiber cores of an optical fiber, and/or via free space. The OFA component 107 may further include a second optical isolator 157 positioned to receive the L-band optical signal via a second fiber core 410L1 of the optical fiber 402. The first optical isolator 147 and the second optical isolator 157 may prevent reflections and possible lasing of the boosted L-band optical signal of the first stage. The OFA component 107 may further include a third optical isolator 158 positioned to receive the C-band optical signal from the first fiber core 410C and the second-stage L-band optical signal from the third fiber core 410L2 of the optical fiber 402. The first optical isolator 147 and the third optical isolator 158 may prevent reflections and possible lasing of the C-band optical input signal. Similarly, the second optical isolator 157 and the third optical isolator 158 may prevent reflections and possible lasing of the boosted L-band optical signal of the second stage.

In various embodiments, the first multiplexer 127, the first optical isolators 147, and/or the third optical isolator 158 may be coupled to the first fiber core 410C such that the C-band optical signal propagates through the first fiber core 410C in a first direction along the length of the optical fiber 402 used to implement the optical fiber coil 137. Moreover, the first multiplexer 127, the first optical isolator 147, and/or the second optical isolator 157 may be coupled to the second fiber core 410L1 such that the L-band signal propagates through the second fiber core 410L1 in a second direction along the length of the optical fiber 402 that is opposite the first direction of the C-band optical signal. Further, the second multiplexer 128, the second optical isolator 157, and/or the third optical isolator 158 may be coupled to the third fiber core 410L2 such that the L-band signal propagates through the third fiber core 410L2 in the second direction along the length of the optical fiber 402 that is opposite the first direction of the C-band optical signal. Such propagation of the C-band optical signal and the L-band optical signal in opposite directions may reduce cross-talk between the C-band optical signal and the L-band optical signals as they traverse the same length of the optical fiber 402.

The OFA component 107 may also include a gain flattening filter (GFF) 167 which flattens the gain of the boosted C-band optical signal and/or the boosted L-band optical signal to ensure a similar gain is obtained across the C-band of the resulting C-band optical output signal and across the L-band of the resulting L-band optical output signal. While FIG. 7 depicts the GFF 167 positioned after the third optical isolator 158, the GFF 167 in some embodiments may be positioned between the optical fiber coil 137 and the third optical isolator 158.

An optical input monitor 177 may be positioned at an optical input of the OFA component 107. The optical input monitor 177 may include one or more optical sensors (e.g., one or more photo-diodes) that sense one or more characteristics (e.g., average power) of the C-band optical input signal and the L-band optical input signal as they enter the OFA component 107. The optical input monitor 177 may further generate one or more electrical signals that are representative of the sensed one or more characteristics of the C-band optical input signal. The optical input monitor 177 may further generate one or more electrical signals that are representative of the sensed one or more characteristics of the L-band optical input signal.

Similarly, an optical output monitor 187 may be positioned at an optical output of the OFA component 107. The optical output monitor 187 may comprise one or more optical sensors (e.g., one or more photo-diodes) that sense one or more characteristics (e.g., average power) of the C-band optical output signal and the L-band optical output signal as they exit the OFA component 107. The optical output monitor 187 may further generate one or more electrical signals that are representative of the sensed one or more characteristics of the C-band optical output signal. The optical output monitor 187 may further generate one or more electrical signals that are representative of the sensed one or more characteristics of the L-band optical output signal. Via such electrical signals, optical gain may be monitored and proper operation of the OFA component 107 may be assessed.

The OFA component 107 of FIG. 7 may provide a C-band optical signal and an L-band optical signal with optical gain using a single length (e.g., 17 meter) of multi-core optical fiber 402. Conversely, the EDFA component 101 of FIG. 1 uses a first length (e.g., 5 meters) of a first optical fiber to provide optical gain for a C-band optical signal and the EDFA component 103 of FIG. 3 uses a second length (e.g., 6 meters) of an optical fiber to provide first-stage optical gain for an L-band optical signal and a third length (e.g., 17 meters) of an optical fiber to provide second-stage optical gain for the L-band optical signal. Thus, one may reduce the total length of optical fiber used to provide optical gain for a C-band optical signal and an L-band optical signal by using the OFA component 107 of FIG. 7 instead of both the EDFA component 101 of FIG. 1 and the EDFA component 103 of FIG. 3. For example, the OFA component 107 may use 17 meters of the multi-core optical fiber 402, whereas the EDFA component 101 and the EDFA component 103 may combine to use 28 meters (i.e., 5 meters+6 meters+17 meters) of erbium-doped optical fiber.

The present disclosure includes reference to certain examples, however, it will be understood by those skilled in the art that various changes may be made and equivalents may be substituted without departing from the scope of the disclosure. In addition, modifications may be made to the disclosed examples without departing from the scope of the present disclosure. Therefore, it is intended that the present disclosure not be limited to the examples disclosed, but that the disclosure will include all examples falling within the scope of the appended claims.

What is claimed is:

1. An optical fiber, comprising
a first fiber core doped with rare-earth ions;
a second fiber core doped with rare-earth ions; and
a cladding surrounding each of the first fiber core and the second fiber core;
wherein a second concentration of rare-earth ions in the second fiber core is greater than a first concentration of rare-earth ions in the first fiber core.

2. The optical fiber of claim 1, wherein the rare-earth ions doped in the first fiber core and the second fiber core include erbium ions.

3. The optical fiber of claim 1, comprising:
a third fiber core doped with rare-earth ions; and
wherein the cladding further surrounds the third fiber core; and
wherein a third concentration of rare-earth ions in the third fiber core is less than the second concentration of rare-earth ions in the first fiber core.

4. The optical fiber of claim 1, comprising:
a third fiber core doped with rare-earth ions; and
wherein the cladding further surrounds the third fiber core; and
wherein a third concentration of rare-earth ions in the third fiber core is greater than the first concentration of rare-earth ions in the first fiber core.

5. The optical fiber of claim 4, wherein the rare-earth ions doped in the first fiber core, the second fiber core, and the third fiber core include erbium ions.

6. The optical fiber of claim 1, wherein the second concentration of rare-earth ions in the second fiber core is greater than 105% of the first concentration of rare-earth ions in the first fiber core.

7. The optical fiber of claim 1, wherein the second concentration of rare-earth ions in the second fiber core is greater than 120% of the first concentration of rare-earth ions in the first fiber core.

8. The optical fiber of claim 1, wherein the second concentration of rare-earth ions in the second fiber core is greater than 200% of the first concentration of rare-earth ions in the first fiber core.

9. The optical fiber of claim 1, wherein the second concentration of rare-earth ions in the second fiber core is greater than 300% of the second concentration of rare-earth ions in the first fiber core.

10. An optical amplifier, comprising:
an optical fiber coil comprising a single length of optical fiber, wherein the single length of optical fiber comprises a first fiber core doped with rare-earth ions, a second fiber core doped with rare-earth ions, and a cladding surrounding each of the first fiber core and the second fiber core, and wherein a second concentration of rare-earth ions in the second fiber core is greater than a first concentration of rare-earth ions in the first fiber core;
one or more pumps configured to generate one or more pump lights;
one or more first multiplexers configured to:
mix at least one of the one or more pump lights with a first optical signal of a first waveband and direct a mixed first optical signal into the first fiber core of the optical fiber coil; and
mix at least one or the one or more the pump lights with a second optical signal of a second waveband and direct a mixed second optical signal into the second fiber core of the optical fiber coil.

11. The optical amplifier of claim 10, wherein the mixed first optical signal traverses the optical fiber coil in a first direction and the mixed second optical signal traverses the optical fiber coil in a second direction opposite the first direction.

12. The optical amplifier of claim 10, comprising a gain flattening filter configured to flatten a gain of a boosted first optical signal across the first waveband and a boosted second optical signal across the second waveband.

13. The optical amplifier of claim 10, comprising one or more optical isolators configured to prevent lasing of the first optical signal and to prevent lasing of the second optical signal.

14. The optical amplifier of claim 10, wherein:
the single length of optical fiber comprises a third fiber core doped with rare-earth ions;
a third concentration of rare-earth ions in the third fiber core is greater than the first concentration of rare-earth ions in the first fiber core; and
the optical amplifier comprises a second multiplexer configured to mix at least one of the one or more pump lights with a boosted second optical signal from the second fiber core and direct a mixed boosted second optical signal into the third fiber core of the optical fiber coil.

15. The optical amplifier of claim 14, wherein:
the second concentration of rare-earth ions in the second fiber core is greater than 110% of the first concentration of rare-earth ions in the first fiber core; and
the third concentration of rare-earth ions in the third fiber core is greater than 300% of the first concentration of rare-earth ions in the first fiber core.

16. The optical amplifier of claim 10, comprising:
one or more optical input monitors configured to sense one or more characteristics of the first optical signal and the second optical signal as they enter the optical amplifier and generate one or more electrical signals representative of the sensed one or more characteristics of the first optical signal and the second optical signal as they enter the optical amplifier; and
one or more optical output monitors configured to sense one or more characteristics of a boosted first optical signal and a boosted second optical signal as they exit the optical amplifier and generate one or more electrical signals representative of the sensed one or more characteristics of the boosted first optical signal and the boosted second optical signal as they exit the optical amplifier.

17. The optical amplifier of claim 10, wherein the rare-earth ions doped in the first fiber core and the second fiber core include erbium ions.

18. The optical amplifier of claim 10, wherein the second concentration of rare-earth ions in the second fiber core is greater than 110% of the first concentration of rare-earth ions in the first fiber core.

19. The optical amplifier of claim 10, wherein the second concentration of rare-earth ions in the second fiber core is greater than 200% of the first concentration of rare-earth ions in the first fiber core.

20. The optical amplifier of claim 10, wherein the second concentration of rare-earth ions in the second fiber core is greater than 300% of the first concentration of rare-earth ions in the first fiber core.
